(19) United States
(12) Patent Application Publication
(10) Pub. No.: US 2010/0118816 A1
(43) Pub. Date: May 13, 2010

(54) APPARATUS AND METHOD FOR TRANSMITTING DATA IN WIRELESS COMMUNICATION SYSTEM

(75) Inventors: Jee-Yon CHOI, Daejeon (KR); Yoo-Seung SONG, Daejeon (KR); Yun-Joo KIM, Suwon-si (KR); Hyun-Gu PARK, Seoul (KR); Sok-Kyu LEE, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/615,813

(22) Filed: Nov. 10, 2009

(30) Foreign Application Priority Data
Nov. 11, 2008 (KR) 10-2008-0111740

(51) Int. Cl. H04W 72/12

(52) U.S. Cl. 370/329

(57) ABSTRACT

An apparatus for transmitting in a wireless communication system includes: a frame generating unit configured to generate a frame based on user data and to transmit the frame and frame information; a scheduling unit configured to generate a schedule of the frames to be transmitted on a frame-by-frame basis based on the frame information and to transmit the schedule; and a data matching unit configured to match the frames based on the schedule so as to transmit the frames at a time.

### CROSS-REFERENCE TO RELATED APPLICATIONS

The present invention claims priority of Korean Patent Application No. 10-2008-0111740, filed on Nov. 11, 2008, which is incorporated herein by reference.

### BACKGROUND OF THE INVENTION

1. Field of the Invention

The present invention relates to an apparatus and method for transmitting data in a wireless communication system; and, more particularly to an apparatus and method for transmitting data in a wireless communication system.

2. Description of Related Art

Communication systems mean a system for voice communications and data transfer between long distance terminals, they can be categorized into wired communication systems and wireless communication systems. The wired communication system guarantees stable transfer of data and signal because systems are connected through wires, but the mobility of the user is limited. On the other hand, a wireless communication system guarantees mobility, but data transfer condition is unstable and data transmission rate is slower than transmission rate in a wire communication system.

Not like the existing wireless communication which was mostly used for voice communication service, recent wireless communication services are increasingly used in data service area. Also, needs for multimedia services that can satisfy various applications are increasing. To satisfy these various applications, transferring various types of data is required. These various types of data include large capacity multimedia packets. Accordingly, a wireless communication system that can provide high speed data transmit service is required. Also, each service has various specific characters and makes different Quality of Service (QoS). In this reason, techniques for wireless communication systems that have a wide bandwidth for transferring large capacity multimedia packet and can provide suitable QoS for users' need are being developed.

Techniques that simultaneously transmit data through a plurality of antennas in order to transfer multimedia packets and to improve QoS are used. These techniques can increases data transfer speed and obtain profit based on diversity. A representative example to transfer data through multiple antennas is Multiple Input Multiple Output (MIMO). Also, multiple frequency band technology which transfer data through various frequency bands in order to broaden the transmission frequency band is being developed and practically being used.

MIMO system will be described hereinafter.

MIMO system is a wireless communication technology broadening the transmit/receipt frequency band by combining multiple antennas. MIMO is a method of transmitting different signal simultaneously through different antenna and combining signals transmitted from the antennas together at the receiver, which enables to use broad band and increase communication speed. Theoretically, the MIMO system has the effect that use of 2 antennas widens 2 times of its data rate, and use of 3 antennas widens 3 times of its data rate.

In case of wireless LAN, since available frequency band is limited, it is difficult to increase transmission speed or range by widening the available frequency band for a user. In this reason, MIMO system allows to broaden the frequency band by using multiple antennas in the limited space by increasing the access points. Also, since the multiple antennas receive the signals transmitted through various routes, transmission and receipt of signals are stable and communication efficiency can be increased in an obstacle surrounded condition.

The multiple frequency band technique widens the frequency band by using more than one frequency band and can transmit large capacity data simultaneously. Also, compared to the single frequency band technique, the multiple frequency band technique can reduce burst errors occurred during communication in a bad communication condition by sending dispersed data through diverse frequency band.

The MIMO system which uses multiple frequency bands and multiple antennas can transmit one and more data stream simultaneously by using diverse transmitting routes. Because MIMO system uses diverse transmitting routes, burst errors in each transmit route can occur in a different rate. To control the error rate, in the MIMO system using the multiple frequency bands and the multiple antennas, a type that the physical layer uses the same transmission method for the multiple frequency bands and the multiple antennas, and a type that the physical layer uses different modulation and coding method for each antenna in a different way from MAC layer in order to increase system transmit efficiency.

An apparatus for transmitting data using the multiple frequency bands and the multiple antennas mentioned above will be described referred to the attached drawings hereinafter.

FIG. 1 is diagram illustrating a wireless communication system diagram using multiple frequency bands and multiple antennas.

A base station 120 includes multiple antennas and transmits data to terminals 131 and 132 through the multiple frequency bands and the multiple antennas. Also, the base station 120 receives data transmitted from the terminal 131 and 132 through the multiple frequency bands and the multiple antennas. The base station 120 can be connected to a data communication equipment or a data communication network 110 either by wire or wireless. In FIG. 1, it is presumed that the base station 120 is connected to the data communication equipment or the data communication network 110 by the wire. Also, the terminal 131 and 132 can be connected to a different data communication equipment or a data communication network 141, 142 or be connected to the same data communication equipment or the data communication network 141, 142. The communication equipment/data communication network 141, 142 can be connected to the terminal 131, 132 either by wire or wireless. In FIG. 1, it is presumed that the data communication equipment or the data communication network 141, 142 is connected to the terminal 131, 132 by wire.

Operation procedures of FIG. 1 will be described. The base station 120 which receives digital data from the data communication equipment or the data communication network 110 transmits the data to the terminal 131, 132 through multiple frequency bands and multiple antennas. The transmitted data are received through the multiple frequency bands and the multiple antennas at the terminal 131, 132 and transmitted to the data communication equipment or a data communication network 141, 142.

The data communication equipment or the data communication network 141, 142 which is connected to the terminal 131, 132 transmits the data, and the terminal 131, 132 transmits the data to the base station 120 through the multiple frequency bands and the multiple antennas. The base station 120 transmits the data received through the multiple frequency bands and the multiple antennas to the data communication equipment or the data communication network 110 which is connected to the base station 120.

FIGS. 2A and 2B are block diagrams showing data transmitting/receiving apparatus. FIGS. 2A and 2B show the base station 120 and the terminal 131, 132 of the data transmitting/receiving apparatus in FIG. 1 on the basis of a layer.

With reference to FIG. 2A, data transmitting procedure at the transmitting unit will be described on the basis of operation in each layer. A service data matching unit 211 receives the data from the data communication equipment or the data communication network and transmits the data to a MAC layer transmitting unit 212. The MAC layer transmitting data process unit 212 receives the data from the service data matching unit 211. A frame generator 212a generates an appropriate frame for the transmission type and sends the data to a physical layer transmitting unit 213. The physical layer transmitting unit 213 receives frames generated at the MAC layer transmitting unit 212. A modulator 213a modulates the received data with an appropriate modulation type for the data, and an encoder 213b encodes the data to be optimized to the wireless communication surrounding and transmit speed. A transmitter 213c decides the frequency in order to transmit the data and sends the data to a data transmitting antenna 214. The data transmitting antenna 214 transmits the data. Descriptions of general functions processed in the physical layer which is not required in the present invention will be omitted.

With reference to FIG. 2B, data receiving procedure at the receiving unit will be described on the basis of operation in each layer. The physical layer receiving unit 222 receives the data from a data receiving antenna 221. A receiver 222c of the physical layer receiving unit 222 collects data from the receiving antenna, and a decoder 222b decodes data which is encoded at the encoder 213b of the physical layer transmitting unit 213. A demodulator 222a of the physical layer receiving unit 222 demodulates the modulated signals at the modulator 213a of the physical layer transmitting unit 213 and transmits the data to a MAC layer receiving unit 223. The MAC layer receiving unit 223 receives data from the physical layer receiving unit 222. An error checking unit 223a checks the error of the received data and a packet scheduler 223b sorts the data and sends the sorted data to a service data matching unit 224. The service data matching unit 224 receives data from the MAC layer receiving unit 223 and determines whether the destination of the data is a terminal of a user or a data communication equipment or data communication network. If the destination of the data is a terminal of the user, information is sent to the user by a upper layer application unit 226. If the destination of the data is a base station or a relay station to transmit the data to another network, data is sent to a designated communication equipment or a data communication network through a data transmitting unit 225.

In the communication method described above, MAC layer does not send data packets by an appropriate scheduling method for the multiple frequency bands or the multiple antennas but by the same scheduling method. Accordingly, if channel status gets worse and error rate of transmission path through some frequency bands and some antennas abruptly increases, packet loss rate abruptly increases. Therefore, it is needed a data transmitting apparatus and method that prevents from burst error by transmitting each of data packets in the MAC layer using independent frequency band and a scheduling method which fits to the independent frequency band, to thereby increase the transmission efficiency.

### SUMMARY OF THE INVENTION

An embodiment of the present invention is directed to an apparatus and method for transmitting data to improve a data transfer speed.

Another embodiment of the present invention is directed to an apparatus and method for transmitting data to avoid burst errors.

Another embodiment of the present invention is directed to an apparatus and method for transmitting data to provide QoS to the user.

In accordance with an embodiment of the present invention, an apparatus for transmitting in a wireless communication system, includes: a frame generating unit configured to generate a frame based on user data and to transmit the frame and frame information; a scheduling unit configured to generate a schedule of the frames to be transmitted on a frame-by-frame basis based on the frame information and to transmit the schedule; and a data matching unit configured to match the frames based on the schedule so as to transmit the frames at a time.

In accordance with another embodiment of the present invention, a method for transmitting data in a wireless communication system, includes: generating a frame based on user data and to transmit the frame and frame information; generating a schedule of the frames to be transmitted on a frame-by-frame basis based on the frame information and to transmit the schedule; and matching the frames based on the schedule so as to transmit the frames at a time.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a wireless communication system diagram using multiple frequency bands and multiple antennas.

FIGS. 2A and 2B are block diagrams showing data transmitting/receiving apparatus.

FIG. 3 is a detailed block diagram of a transmitting apparatus in accordance with an embodiment of the present invention.

FIG. 4 is a detailed block diagram of a transmitting apparatus in accordance with another embodiment of the present invention.

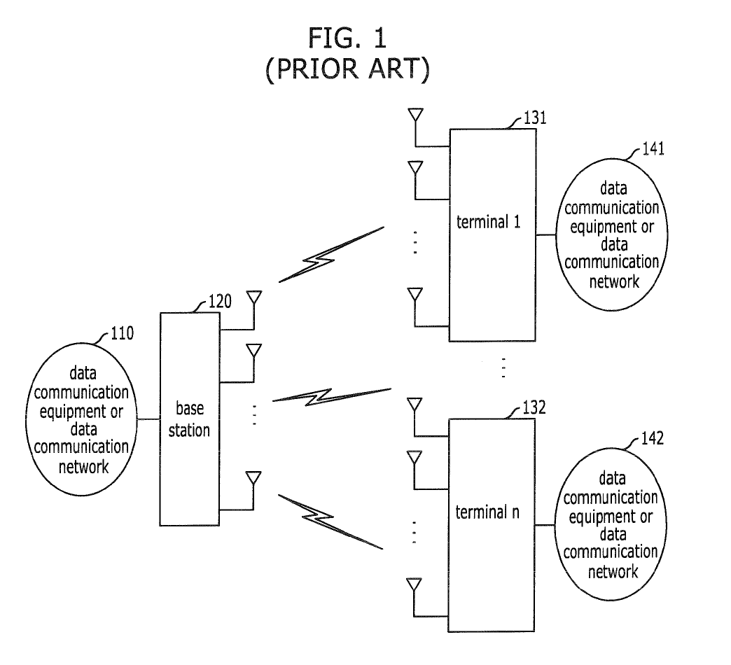

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

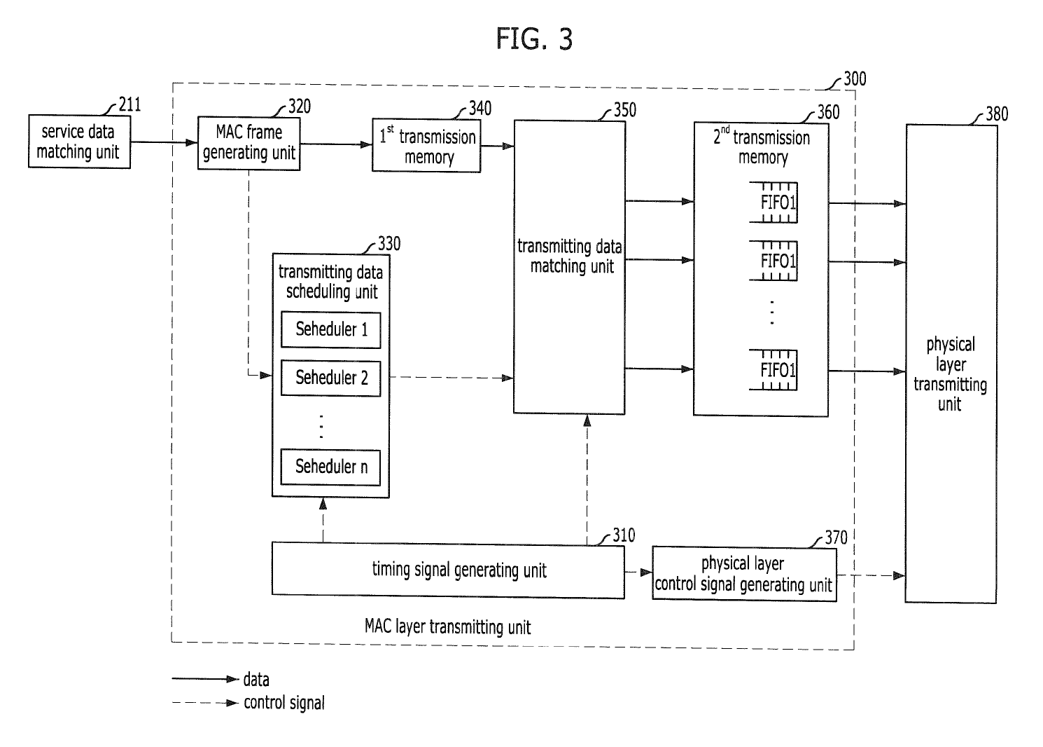

FIG. 3 is a detailed block diagram of a transmitting apparatus in accordance with an embodiment of the present invention.

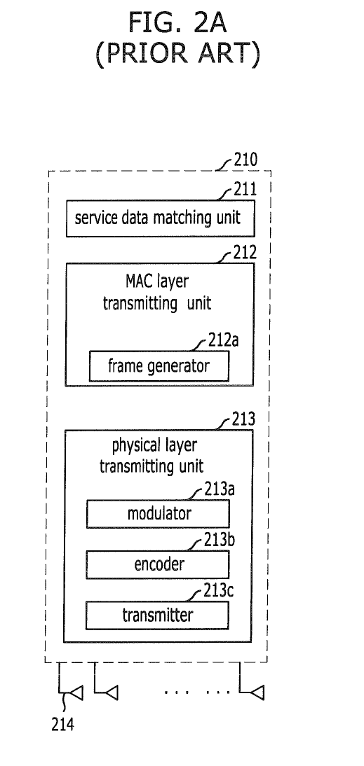

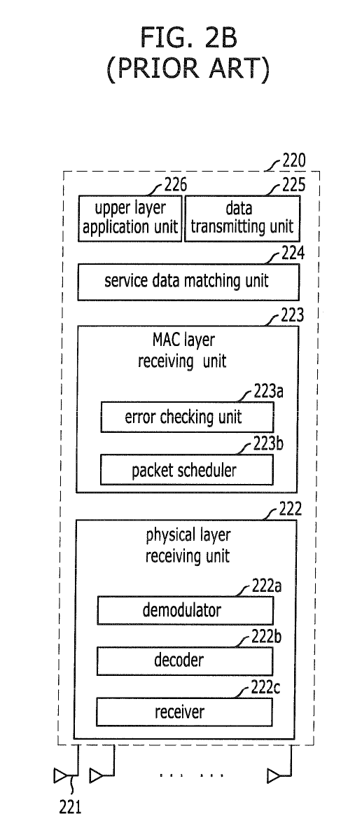

The MAC layer transmitting unit and the physical layer transmitting unit using the multiple frequency bands and the multiple antennas will be explained with reference to FIG. 3. The multiple frequency bands and the multiple antennas are also called as transmission media for transmitting the data. The MAC layer transmitting unit includes a timing signal generating unit 310, a MAC frame generating unit 320, a transmitting data scheduling unit 330, a 1^{st} transmission memory 340, a transmitting data matching unit 350, a 2^{nd} transmission memory 360 and a physical layer control signal generating unit 370. A physical layer transmitting unit 380 receives the data from the MAC layer transmitting unit 300 and sends the data to the transmitting antenna 214. Since the physical layer transmitting unit 380 has the same structures as the physical layer transmitting unit 213 described with reference to FIG. 2A, and detailed description on the physical layer transmitting unit 380 is omitted herein.

Functions of blocks in FIG. 3 will be described hereinafter.

The timing signal generating unit 310 generates timing signals needed for transmitting the MAC frame and provides the timing signals to each functional block. The MAC frame generating unit 320 forms a MAC frame that meets the frame specification based on the input data from the service data matching unit 211 and stores the MAC frame in the 1^{st} transmission memory 340. The MAC frame generating unit 320 sends the MAC frame control information of each MAC frame to the transmitting data scheduling unit 330. The MAC frame control information includes frame length, a sequence number of the MAC frame and address of 1^{st} transmitting memory in which the MAC frame is stored.

The transmitting data scheduling unit 330 includes a plurality of schedulers, and each scheduler operates for one of frequency bands and antennas. The transmitting data scheduling unit 330 provides the MAC frame control information received from the MAC frame generating unit 320 to the schedulers. Each scheduler of the transmitting data scheduling unit 330 generates a MAC frame list describing MAC frames that can be sent for a predetermined time through the corresponding frequency band or the corresponding antenna, and sends the MAC frame list to the transmitting data matching unit 350.

The transmitting data matching unit 350 reads the MAC frame based on the transmitted data memory address which is included in the MAC frame control information on each of the antenna, and sends the MAC frame to the 2^{nd} transmission memory 360. The 2^{nd} transmission memory 360 may be a First Input First Output (FIFO) memory. For easy description, it is supposed that the 2^{nd} transmission memory 360 is the FIFO memory hereinafter.

The 2^{nd} transmission memory 360 stores the MAC frame received from the transmitting data matching unit 350 at the corresponding FIFO for each frequency band or antenna. The physical layer transmitting unit 380 calls the MAC frame from FIFO according to the transmit time and transmits the MAC frame through antenna after the modulation and coding procedure.

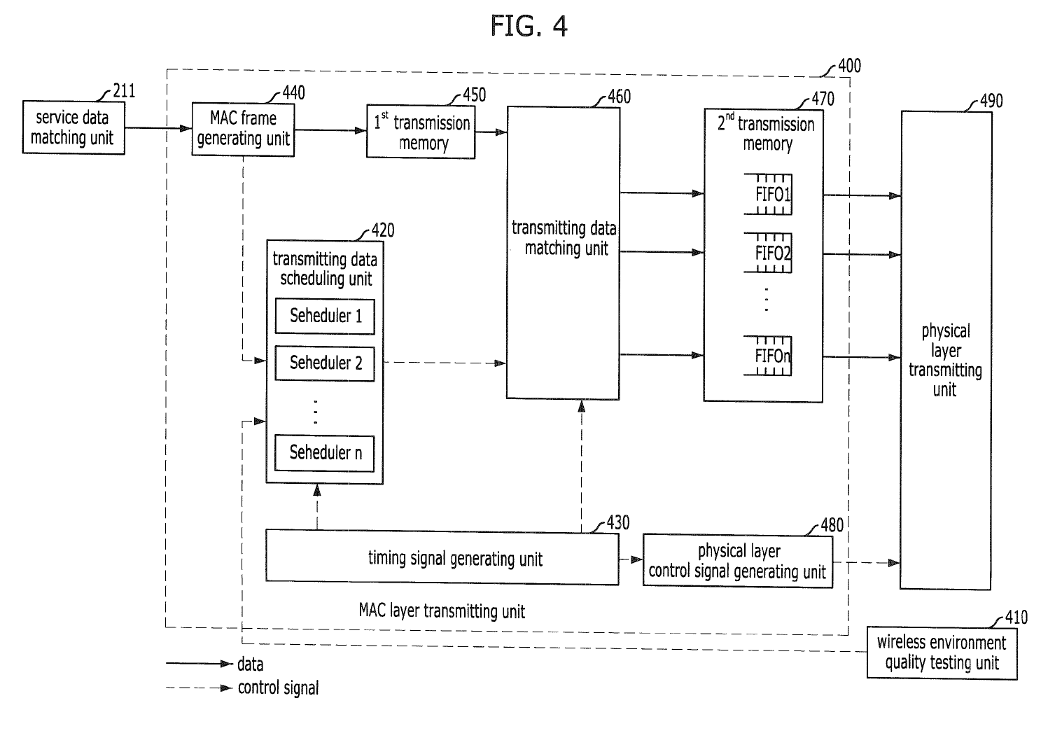

FIG. 4 is a detailed block diagram of a transmitting apparatus in accordance with another embodiment of the present invention.

Comparing FIG. 4 with FIG. 3, the transmitting apparatus in FIG. 4 further includes a wireless environment quality testing unit 410. The wireless environment quality testing unit 410 may be a receiver in general. For example, the receiver checks the signal quality received from the transmitter and sends the signal quality information back to the transmitter. It is supposed that the wireless environment quality testing unit 410 is the receiver hereinafter. In addition, the wireless environment quality testing unit 410 may be also separate equipment that can test the wireless communication quality. The difference between FIG. 3 and FIG. 4 will be explained in detail hereinafter.

The wireless environment quality testing unit 410 for providing the QoS collects channel quality information of each frequency band and antenna and transmits the channel quality information to a transmitting data scheduling unit 420. The transmitting data scheduling unit 420 receives the channel quality information decides the priority between MAC frames and amount of data to be sent based on the channel quality information. The wireless environment quality testing equipment 410 which checks the channel status is located in the physical layer transmitting unit or the MAC layer transmitting unit.

The transmitting data scheduling unit 420, which receives data for QoS from the wireless environment quality testing unit 410, applies a different scheduling according to a network or QoS which the user wants based on the MAC frame control information of the MAC frame generating unit 440. MAC frames that requires high QoS, e.g., video data and audio data, are transmitted through the frequency bands and/or antennas having good channel quality, and allocated to the scheduler that are in charge of the decided frequency band and/or antenna. MAC frames that requires low level of QoS, e.g., FTP data, is transmitted through the frequency bands and/or antennas having a relatively low channel quality, and allocated to the scheduler that are in charge of the decided frequency and/or antenna.

As explained in the embodiment of the present invention, high speed and reliable transmission of data can be performed by using multiple frequency bands and multiple antennas. Also, the QoS that meets the needs of the network or the user can be provided by checking the quality of the wireless channel by the wireless environment quality testing unit 410 and forwards the wireless channel quality information.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting in a wireless communication system, comprising:
a frame generating unit configured to generate a frame based on user data and to transmit the frame and frame information;
a scheduling unit configured to generate a schedule of the frames to be transmitted on a frame-by-frame basis based on the frame information and to transmit the schedule; and
a data matching unit configured to match the frames based on the schedule so as to transmit the frames at a time.

2. The apparatus of claim 1, wherein the frame information includes frame size information and frame quality information.

3. The apparatus of claim 1, wherein the scheduling unit includes a plurality of schedulers each of which decides priority and a transmission media of each frame.

4. The apparatus of claim 3, further comprising:
a memory configured to store output of the data matching unit and to transmit the output of the data matching unit to the transmission media.

5. The apparatus of claim 1, further comprising:
a memory configured to store the frames outputted from the frame generating unit during scheduling of the frames at the scheduling unit.

6. The apparatus of claim 1, further comprising:
a wireless environment quality testing unit configured to collect channel quality information of each frequency band and antenna and to transmit the channel quality information to the scheduling unit.

7. A method for transmitting data in a wireless communication system, comprising:
generating a frame based on user data and to transmit the frame and frame information;
generating a schedule of the frames to be transmitted on a frame-by-frame basis based on the frame information and to transmit the schedule; and
matching the frames based on the schedule so as to transmit the frames at a time.

8. The method of claim 7, wherein in said generating a schedule, each of the frames is independently scheduled for QoS of the frame and a transmission media.

9. The method of claim 8, wherein in said generating a schedule, each of the frames is scheduled based on quality of the transmission media so as that the frame is transmitted through the transmission media appropriate to the QoS of the frame.

10. The method of claim 8, wherein the transmission media transmits the data through multiple frequency bands and multiple antennas.

11. The method of claim 7, further comprising:
storing the frames based on the schedule until the frames are transmitted through the transmission media.

12. The method of claim 7, further comprising:
collecting channel quality information of each frequency band and antenna and to transmit the channel quality information to the scheduling unit.
